(19) United States
(12) Patent Application Publication
(10) Pub. No.: US 2008/0148253 A1
(43) Pub. Date: Jun. 19, 2008

(54) AUTOMATIC SOFTWARE LICENSE RECONCILIATION

(75) Inventors: Ashutosh Badwe, Redmond, WA (US); Ram P. Papatla, Sammamish, WA (US); David James Armour, Bellevue, WA (US); Ross Norrie, Bellevue, WA (US)

Correspondence Address: SENNIGER POWERS LLP (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/611,756

(22) Filed: Dec. 15, 2006

(51) Int. Cl. G06F 9/445

(52) U.S. Cl. 717/174

(57) ABSTRACT

Reconciling an installed software application with a software license. A discovery agent is deployed to each computing device at a user site, and each deployed discovery agent identifies information associated with access to the installed software application on the respective computing device. The identified information is aggregated to determine a present utilization of the installed software application on the computing devices at the user site. Usage rights associated with a software license for the software application is correlated with the present utilization of the software application. A resulting utilization is created as a function of the correlation and a report is provided indicating the resulting utilization.

### BACKGROUND

Network administrators typically manage the procurement and deployment of software applications or software application suites. For example, the procurement involves purchasing the necessary number of software licenses for the users in an enterprise computer network setting. During deployment, the network administrators are responsible for ensuring that the usage of the software applications in the network complies with the usage rights defined in the purchased software licenses, including that the number of installed applications does not exceed the number of purchased software licenses.

In cooperating with software vendors' auditing practices, the network administrators typically perform an internal audit or investigation comparing the number of purchased software licenses with the installed software applications. Typically, the network administrators may manually record the number of installed software applications while installing the software applications. The administrators may also record the user and/or the workstation associated with the particular installed software applications. Such a manual practice can be inefficient and prone to errors because of frequent changes in personnel, usage, hardware, and the like.

In another conventional example, administrators in a mainframe computing environment can monitor or track the number of calculations or accesses of a certain function to determine the usage of a particular software application on the mainframe computer. Other conventional practices involve administrators or software vendors installing a monitoring application on each computer for monitoring the usage of the installed software applications on each computer. The monitoring application logs the monitored usage in each computer, and, over time, the logged usage information is sent to the software vendor for analysis. Subsequently, the software vendor prepares a usage report for the administrators to review.

While this monitoring application implementation is more efficient than the previous manual monitoring process, this practice requires that each computer provides the necessary processing power for the monitoring application. In addition, each computer must allot sufficient storage space for the monitoring application to store the logged usage information. In addition, the administrators also need to closely monitor any changes to the software licenses and/or usage rights associated with the software licenses.

### SUMMARY

Embodiments of the invention overcome one or more deficiencies of conventional license reconciliation practices by providing automated discovery of actual utilization of software on the computing devices at a user site using one or more discovery agents. The discovery agents are deployed to the computing devices instead of being run on the computing devices to continuously monitor usage of the software. In addition, aspects of the invention advantageously analyze the discovered utilization information of the software and the software usage rights to reconcile the software licenses associated with the software and to generate reports representing the reconciliation.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating a system for reconciling a software application installed on computing devices at a user site with a software license according to an embodiment of the invention.

FIG. 2 is a block diagram illustrating a discovery agent identifying information associated with access to an installed software application on the computing devices of the user site according to an embodiment of the invention.

FIG. 3 is an exemplary report including a resulting utilization generated according to an embodiment of the invention.

FIG. 4 is a block diagram illustrating an exemplary computer-readable medium on which aspects of the invention may be stored.

FIG. 5 is a flow diagram illustrating operations for determining compliance of a software application with a software license associated with the software application according to an embodiment of the invention.

Corresponding reference characters indicate corresponding parts throughout the drawings.

### DETAILED DESCRIPTION

Embodiments of the invention conveniently solve the problems of manually tracking and constantly monitoring installed software applications to avoid a violation of software licenses. Contrary to existing mainframe usage monitoring of the number of calculations or processes, exemplary embodiments of the invention use discovery agents to identify information relating to each of the software applications installed on a computer.

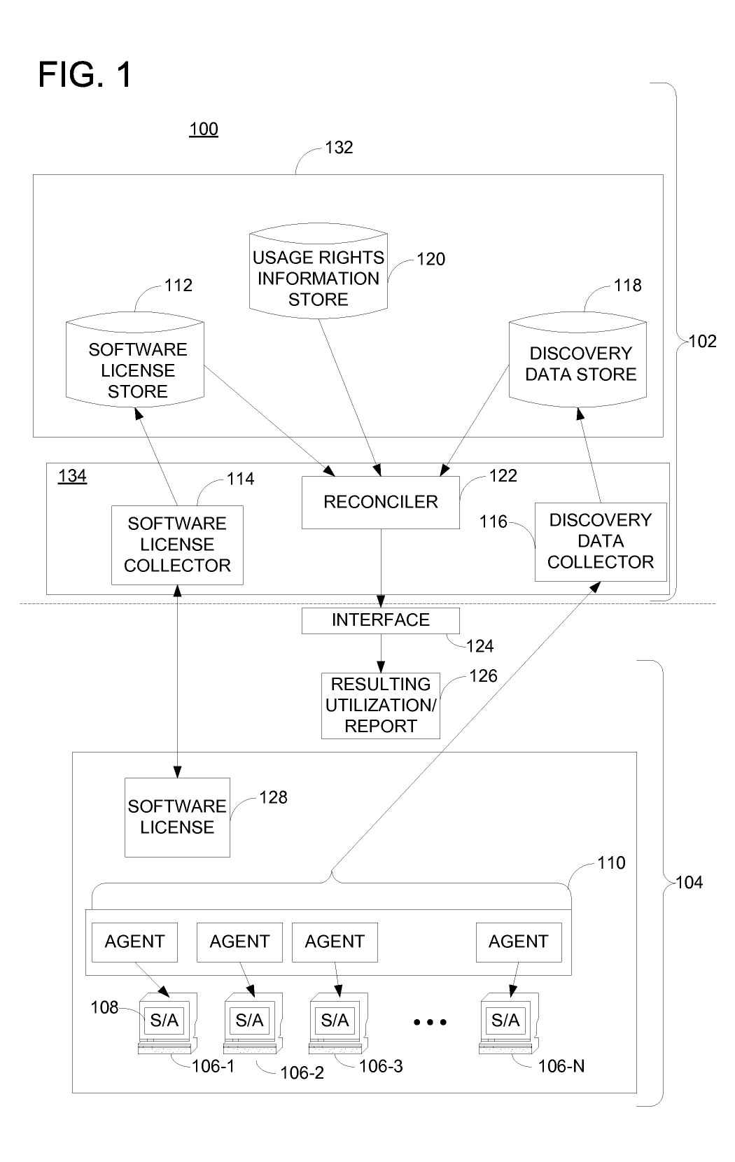

Referring now to FIG. 1, a block diagram illustrates a system 100 for reconciling actual software application usage with its licensed usage. For illustration purposes only and not by limitation, the system 100 may include a software reconciliation site 102 and a user site 104, which has a number of computing devices 106. For example, the software reconciliation site 102 includes servers, Internet servers, or other computing devices hosted or managed by the software application vendor. In another example, the software reconciliation site 102 may include a third-party or a contracting party performing the software reconciliation process for the software vendor. In another aspect of the invention, the user site 104 is not limited to a physical location of a particular user entity. For example, the user site 104 may be an enterprise in which its networked workstations span across one or more geographical locations (e.g., different office locations in Seattle, New York, Chicago, or the like). According to aspects of the invention, the system 100 reconciles a software application 108 installed on the computing devices 106 at the user site 104 with a software license 128.

Still referring to FIG. 1, the user site 104 of the system 100 includes one or more computing devices 106 with the software application 108 installed thereon. Initially, the software application 108 is installed on each of the computing devices 106 at the user site 104. The software application 108 may be software, an operating system, and/or a suite of software or applications. Exemplary embodiments of the invention solve the problem of inefficient, manual methods of tracking installed copies of the software application 108 on each of the computing devices by instead using a discovery agent 110. In one alternative embodiment, the discovery agent 110 may be a collection of computer-executable instructions, computer-executable codes, computer-executable components, a program, or the like that attempts to identify information associated with access to the installed software application 108 on the computing devices 106 of the user site 104. For example, the discovery agent 110 identifies executable files, one or more registry key entries associated with the software application 108, a process log, and a list of active processes in the computing devices 106 at the user site 104. In another alternative embodiment, the discovery agent 110 may be configured to identify a particular type of software application. In yet another alternative embodiment, the discovery agent 110 may be configured to identify one or more types of software applications.

In one exemplary embodiment, the discovery agent 110 is deployed to each of the computing devices 106 from the software reconciliation site 102 rather than running continuously as a background process or the like. In one alternative embodiment, the discovery agents 110 identify information based on per-install or per-client access basis. For example, the software reconciliation site 102 may electronically transmit or send the discovery agent 110 to each of the computing devices 106 via the common communications network. In an alternative embodiment, the discovery agent 110 may be deployed by the administrator(s) at the user site 104. For example, the administrator may receive the discovery agent 110 from the software reconciliation site 102 and subsequently may deploy the discovery agent 110 at a later time (e.g., off-peak time) that is more convenient to the user site 104.

In addition, the software reconciliation site 102 also includes a software license store 112 and a usage rights information store 120, including usage rights information associated with the software license 128. Although illustrated as separate data stores, it is to be understood that the software license store 112 and the usage rights information store 120 may be embodied by a single data store in an embodiment of the invention.

As the discovery agent 110 discovers or identifies the information or per-installation information associated with the access of the installed software application 108 in an automated fashion, a software license collector 114 at the software reconciliation site 102 also retrieves or collects data associated with the software license 128 of the software application 108 at the user site 104. For example, the administrator(s) at the user site 104 may compose a file, spreadsheet or other data or information format relating to the software license 128 in the software license data store 112. For example, the software license data store 112 may store information relating to the software applications installed at the user site 104. The information in the software license data store 112 may include one or more of the following relating to a software application: a name of the manufacturer, version information, type of license, date of purchase, number of license purchased, or the like. In one exemplary embodiment, the software license data store 112 may be at the user site 104. In an alternative embodiment, the software reconciliation site 102 may provide a storage area for storing the data from one or more user sites 104. Once the software license data store 112 includes the data associated with the software license 128, the software license collector 114 retrieves data associated with the software license for the software application 108 from the software license data store 112.

Alternatively, in this aspect, the computing devices 106 at the user site 104 may be connected via a wired or wireless communication channel. The software reconciliation site 102 and the user site 104 are connected via a common communications network (not shown), such as a local area network (LAN) and a wide area network (WAN), but may also include other networks. It is known to those skilled in the art that LAN and/or WAN may be a wired network, a wireless network, a combination thereof, and so on. Such networking environments are commonplace in offices, enterprise-wide computer networks, intranets, and global computer networks (e.g., the Internet).

As an example, the computing devices 106 may include one or a combination of the following: a personal computer (PC), a workstation, a cellular phone, a portable digital device, a personal digital assistance (PDA), a pocket PC, a digital media player, and any other digital devices in the user site 104. As known to those skilled in the art, the computing devices 106 include a combination of the following (not shown): a processing unit, one or more computer-readable media, an internal bus system coupling to various components within the computing devices 106, Input/Output devices, a networking device, and other devices. In one alternative embodiment, computer-readable media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, radio frequency (RF), infrared, and other wireless media, are examples of communication media. Combinations of any of the above are also included within the scope of computer readable media.

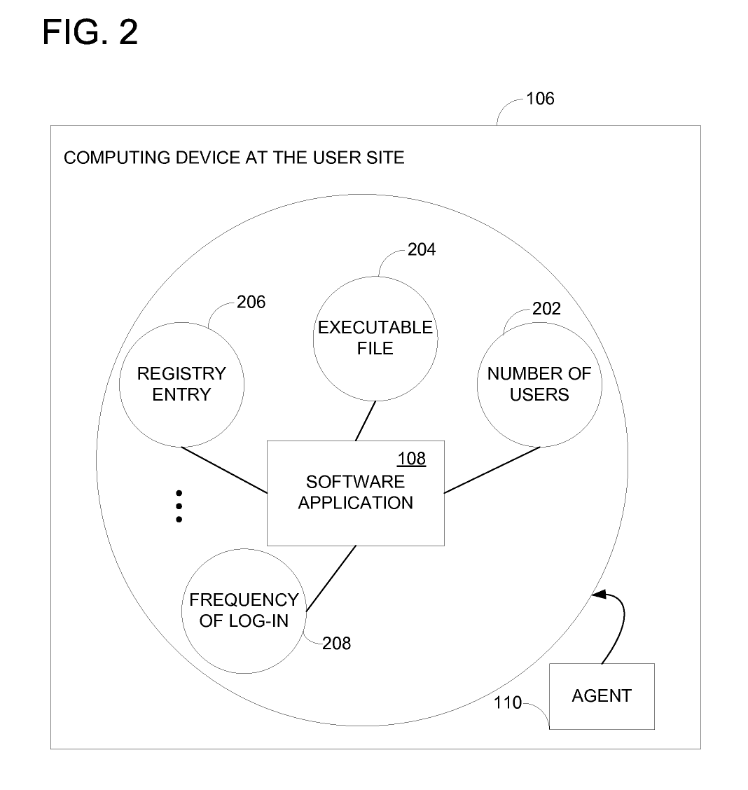

FIG. 2 is a diagram illustrating an exemplary discovery agent 110 identifying information associated with access to an installed software application 108 on the computing device 106 of the user site 104 according to an embodiment of the invention. For example, the software application 108 may be associated with one or more of the following pieces of identifiable information: a number of users 202, one or more executable files 204, one or more registry entries 206, and log-in frequency by users 208, among others. In an alternative embodiment, information associated with access of the installed software application also includes, version information of the installed software application and software vendor information, among others. Other access information associated with the installed software application may be included without departing from the scope of the embodiments of the invention.

Referring again to FIG. 1, once each discovery agent 110 identifies information associated with access of the installed software application 108, each discovery agent 110 sends or transmits the identified information to a discovery data collector 116. For example, the discovery agents 110 may transmit such information back to the discovery data collector 116 once each discovery agent completes identifying information associated with the installed software application 108. Once the discovery data collector 116 receives the responses from the discovery agents 110, the discovery data collector may store the discovered data in a discovery data store 118. The discovery data is aggregated from the received responses to determine a present or actual utilization of the installed software application on the computing devices 106 at the user site 104. For example, the responses from the discovery agents 110 include at least executable files, registry, logs, and running processes, number of software installations, and the discovered data is correlated or aggregated to determine the utilization of the installed software application.

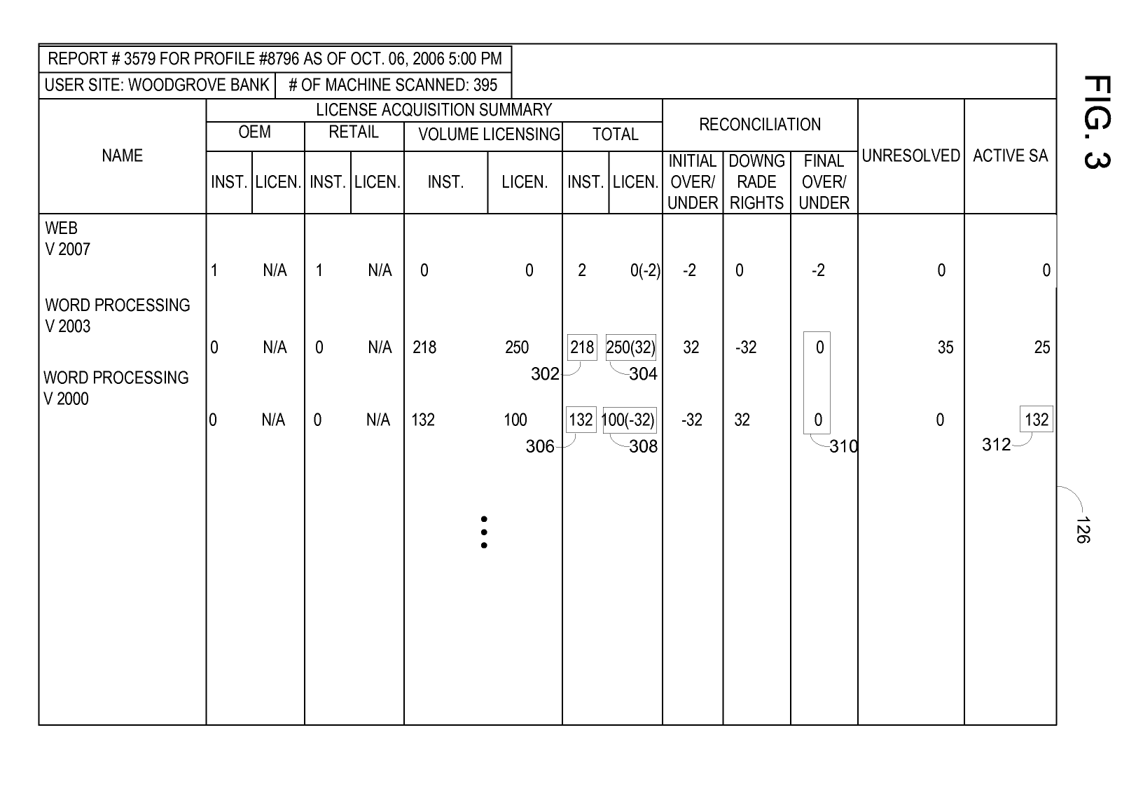

In another example, the usage rights information stored in the usage rights information store 120 is correlated with the software license 128 for the software application 108. For example, the usage information associated with the software license 128 is compared or matched with the software license to determine whether a particular type of usage rights may be part of the software license. For example, as shown in FIG. 3 (to be discussed in further detail below), an exemplary report including the resulting utilization, a retail type of software license may only permit one installation in one computing device for one user, while a volume license type of software license may permit one installation in one computing device for multiple users. Other methods of classifying usage rights with the software license 128 may be used without departing from the scope of embodiments of the invention.

In one embodiment, a reconciler 122 implemented by a software component, for example, creates a resulting utilization based on the determined utilization of the software application 108 at the user site 104, the usage rights, and the software license 128. For example, the reconciler 122 analyzes or interprets the determined utilization of the installed software application 108 on the computing devices 106, the usage rights associated with the software license 128, and the software license 128 to determine whether the installed software application 108 is being used in compliance with the software license 128 and the usage rights. In an alternative embodiment, the usage rights information in the usage rights information store 120 is formatted or schematized such that the presentation of the usage rights information is uniform and consumed by the reconciler 122 without additional parsing or processing. By so doing, embodiments of the invention include technical features that enable a system and method of automated discovery of license agreements of the installed software application 108 at the user site 104, automated discovery of usage rights granted to the user site under the agreements, and automated reconciling of the actual usage or the resulting utilization of the software application 108 with the usage rights documented in and associated with the license agreements. The resulting utilization is included in a report 126 to be provided to the user site 104 via an interface 124. For example, the report 126 may be transmitted from the software reconciliation site 102 to the user site 104 via a web page, an electronic mail, messaging system (e.g., instant messages), or other means of communications (e.g., facsimile). The interface 124 may include a web site or a common communications network.

In an alternative embodiment, the software license store 112, the usage rights information store 120, and the discovery data store 118 may be part of a memory area 132. In another alternative embodiment, the software reconciliation site 102 includes a processor 134 which may process all or a part of the operations performed by the software license collector 114, the reconciler 122, and the discovery data collector 116.

FIG. 3 illustrates an exemplary report 126 including the resulting utilization generated according to an embodiment of the invention. In one embodiment, the discovery agents 110 identify information for one or more software applications created by one particular software company. As illustrated in FIG. 3, the report 126 includes the resulting utilization of one or more software applications based on one or more types of discovery agents. For example, the report 126 shows one or more software applications such as “Web, V. 2007,” “Word Processing v. 2003,” and “Word Processing V. 2000”. In particular, for the software “Word Processing v. 2003,” the report 126 shows that in block 302 there are 218 total installations at the computing devices 106 at the user site 104. The report 126 also shows that in block 304 there are 250 software licenses purchased. Similarly, for software “Word Processing v. 2000,” there are, in block 306, 132 installations on the computing devices 106 at the user site 104. However, there are only 100 software licenses purchased at the user site 104.

At a first glance, it may appear that the user site 104 has violated the software license for the software application “Word Processing V. 2000”. However, the reconciler 122 of the embodiments of the invention creates the resulting utilization based on the determined utilization, the software licenses, and the usage rights information associated with the software license which shows that the user site 104 has complied with the software licenses. The resulting utilization shows that due to the software “Web Processing V. 2003” is an upgrade version of the software “Web Processing V. 2000” and the excess 32 licenses of the “Web Processing V. 2003” may apply to the “Web Processing V. 2000”. Therefore, even though the report 126 shows the installation of the software “Web Processing V. 2000” has exceeded the number of purchased licenses, the resulting utilization shows that, in block 310, the result of the reconciliation shows an even balance of the installed software and purchased software licenses.

As such, embodiments of the invention create or generate a tangible and technical effect of an automated reconciliation of software licenses and the installed software applications. Embodiments of the invention also advantageously enhance the maintenance of software application compliance by having the software reconciliation site 102 analyze and interpret the utilization of the software application at the user site 104. Aspects of the invention also eliminate the manual processes required by previous practices by requiring the administrators at the user site 104 track or monitor the usage of the software applications. The solution achieved by various embodiments of the invention creates an automated software license reconciliation environment in which at least one of the following is accomplished: 1. actual utilization of software on the computing devices; 2. automated discovery of license agreements at the user site 104; 3. automated discovery of usage rights granted to the user site under the provisions of the license, 4. automated reconciliation of aggregated actual utilization of software per licensed product with the aggregated usage rights per product for the user site; and 5. presentation of reconciliation statement to the user site.

Alternatively, embodiments of the invention create flexibility on the software vendor's part by maintaining and managing the usage rights information store so that, in the event of changes, the software reconciliation site 102 can accurately and conveniently update the resulting utilization in the report without requiring the user site 104 to keep track of the different changes or updates to the usage rights information.

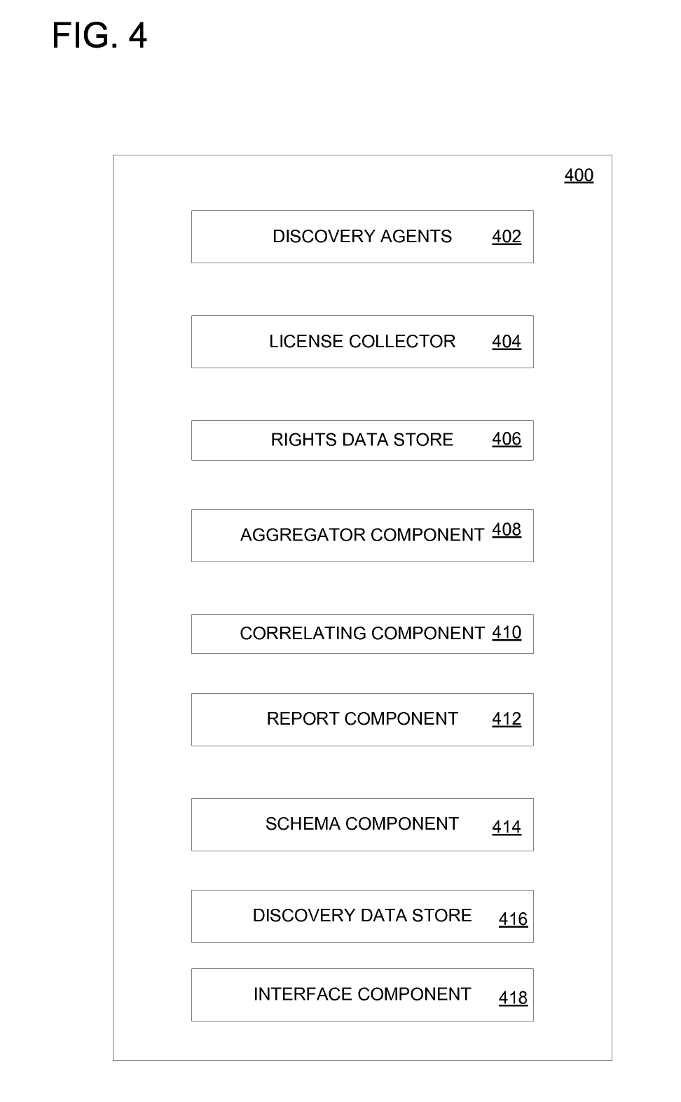

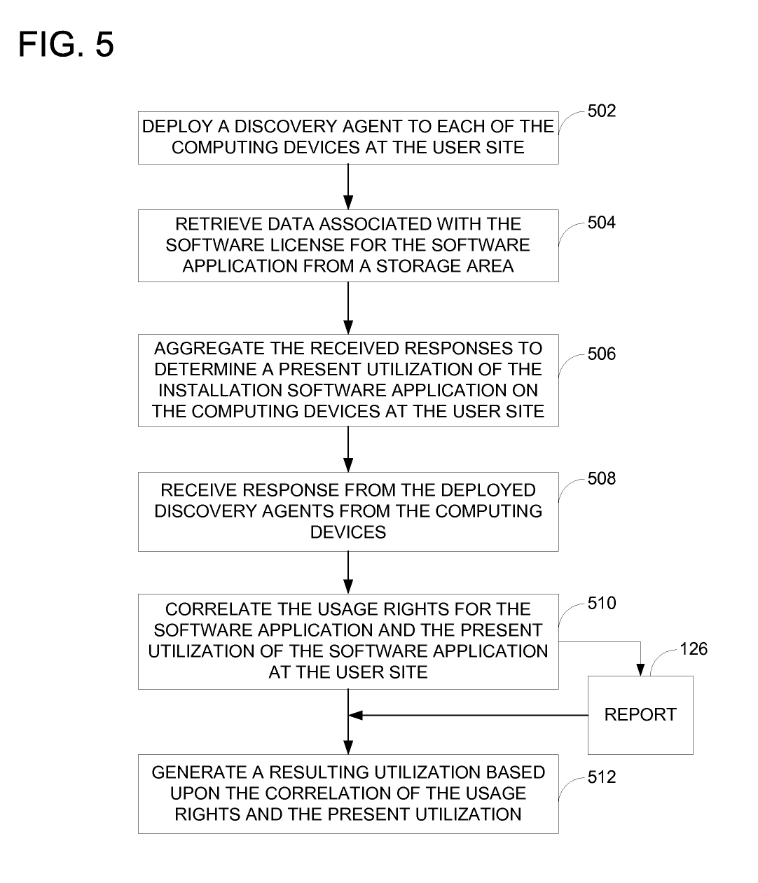

FIG. 4 is a block diagram illustrating an exemplary computer-readable medium 400 on which aspects of the invention may be stored. In one embodiment, the computer-readable medium 400 includes one or more computer-executable components for performing operations illustrated in FIG. 5. For example, one or more discovery agents 402, being deployed, at 502, to each of the computing devices 106 at the user site 104, identify information associated with access to the installed software application 108 on the computing devices 106 of the user site 104. A rights data store 406 stores information relating to usage rights associated with the software license data. At 504, a license collector 404 collects or retrieves software license data from the user site 104. In one embodiment, the software license data specifies usage rights associated with the software license for the software application. In one embodiment, the responses include data associated with information associated with access to the installed software application at each of the computing devices.

At 506, an aggregator component 408 aggregates the information associated with access to the installed software application identified by the discovery agents 402 to determine a present utilization of the installed software application on the computing devices at the user site. At 508, a correlating component 410 correlates the usage rights associated with the software license for the software application and the present utilization of the installed software application. In one embodiment, the correlating component 410 determines a resulting utilization as a function of the determined utilization of the software application at the user site, the usage rights, and the software license data. A report component 412 generates a resulting utilization as a function of the correlation of the usage rights and the present utilization. The resulting utilization is included in a report (e.g., report 126). An interface component 418 provides the report 126 to the user site 104. In an alternative embodiment, the computer-readable medium 400 also includes a schema component 414 for formatting the correlated usage rights based on the retrieved software license data in the usage rights information store 120. In another embodiment, a discovery data store 416 receives responses from the deployed discovery agents from the computing devices.

In operation, a computer executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A computerized method for reconciling a software application with a software license, said software application being installed on one or more computing devices at a user site, said computerized method comprising:
deploying a discovery agent to each of the computing devices at the user site, each of said deployed discovery agents identifying information associated with access to the installed software application on a respective computing device at the user site;
receiving responses from the discovery agents deployed to the computing devices, said responses including data representing the identified information associated with the access to the installed software application at each of the computing devices;
aggregating the received responses to determine a present utilization of the software application on the computing devices at the user site;
retrieving, from a storage area, data associated with the software license for the software application, said retrieved data specifying usage rights for the software application;
correlating the usage rights for the software application and the present utilization of the software application at the user site; and
generating a resulting utilization based upon the correlation of the usage rights and the present utilization.

2. The computerized method of claim 1, wherein said aggregating the received responses comprises aggregating the received responses to determine at least one of a number of software installations on the computing devices, a number of users using the software application, and a frequency of use of the software application.

3. The computerized method of claim 1, wherein said deploying the discovery agent comprises deploying the discovery agent to each of the computing devices to identify information associated with access based on per-installation of the software application on each of the computing devices of the user site.

4. The computerized method of claim 1, further comprising formatting the correlation of the usage rights and the present utilization based on the retrieved data associated with the software license from the user site.

5. The computerized method of claim 1, wherein said receiving the responses comprises receiving information associated with executable information of the installed software application, said executable information including at least one of the following: an executable file, a registry key associated with the software application, a process log, and a list of active processes.

6. The computerized method of claim 1, wherein said retrieving data comprises retrieving data associated with the software license for the software application from the storage area at the user site.

7. The computerized method of claim 1, further comprising providing a report indicating the resulting utilization.

8. The computerized method of claim 1, wherein one or more computer-readable media have computer-executable instructions for performing the method of claim 1.

9. A system for resolving a software license for a software application based on installation of said software application on one or more computing devices at a user site, said system comprising:
a license collector for collecting software license data at the user site, said software license data specifying usage rights for the software application;
a memory area for storing information relating to usage rights associated with the software license data;
a processor configured to execute computer-executable instructions for:
receiving responses from one or more discovery agents deployed to the computing devices the user site, said responses including information associated with access to the software application at each of the computing devices;
aggregating the received responses to determine a present utilization of the software application on the computers at the user site;
retrieving software license data from the license collector;
correlating the usage rights specified by the software license data and the present utilization of the software application;
generating a resulting utilization from the correlation of the usage rights and the present utilization; and
an interface for providing a report indicating the resulting utilization.

10. The system of claim 9, wherein the processor is configured to aggregate the received responses to determine at least one of a number of software installations on the computers, a number of users using the software application, and a frequency of use of the software application.

11. The system of claim 9, wherein each of the discovery agents deployed to the computing devices identifies information associated with access based on per-installation of the software application on each of the computing devices at the user site.

12. The system of claim 9, wherein the processor is further configured to format the correlation of the usage rights and the present utilization based on the retrieved software license data.

13. The system of claim 9, wherein the processor is configured to receive information associated with executable information of the installed software application, said executable information including at least one of the following: an executable file, a registry key associated with the software application, a process log, and a list of active processes.

14. The system of claim 9, wherein the interface is configured to provide the report to the user site indicating the resulting utilization.

15. One or more computer-readable storage media having computer-executable components for determining compliance with a software license associated with a software application, said software application being installed on one or more computing devices at a user site, said computer-executable components comprising:
one or more discovery agents, being deployed to each of the computing devices at the user site, for identifying information associated with access to the installed software application on the computing devices of the user site;
a license collector for collecting software license data from a rights data store at the user site, said software license data specifying usage rights associated with the software license for the software application;
an aggregator component for aggregating the information associated with access to the installed software application identified by the discovery agents to determine a present utilization of the installed software application on the computing devices at the user site;
a correlating component for correlating the usage rights associated with the software license for the software application and the present utilization of the installed software application;
a report component for generating a resulting utilization as a function of the correlation of the usage rights and the present utilization and for generating a report indicative thereof.

16. The computer-readable storage media of claim 15, wherein the aggregator component aggregates the received responses to determine at least one of a number of software installations on the plurality of computing devices, a number of users using the software application, and a frequency of use of the software application.

17. The computer-readable storage media of claim 15, wherein each of the one or more discovery agents identifies information associated with access based on per-installation of the software application on each of the computing devices at the user site.

18. The computer-readable storage media of claim 15, further comprising a schema component for formatting the correlation of the usage rights and the present utilization based on the retrieved software license data.

19. The computer-readable storage media of claim 15, further comprising a discovery data store for receiving the information identified by the deployed discovery agents, said information being associated with executable information of the installed software application, said executable information including at least one of the following: an executable file, a registry key associated with the software application, a process log, and a list of active processes.

20. The computer-readable storage media of claim 15, further comprising an interface component for providing the report to the user site indicating the resulting utilization.
